(19) United States
(12) Patent Application Publication
(10) Pub. No.: US 2023/0374339 A1
(43) Pub. Date: Nov. 23, 2023

(54) BASE COATING MATERIAL COMPOSITION AND COATED ARTICLE

(71) Applicant: NIPPON PAINT AUTOMOTIVE COATINGS CO., LTD., Hirakata-shi, Osaka (JP)

(72) Inventors: Yoshiki TAKAIRA, Hirakata-shi, Osaka (JP); Nobusuke JINNO, Hirakata-shi, Osaka (JP); Takunori MATSUFUJI, Hirakata-shi, Osaka (JP); Katsumi MIZUGUCHI, Hirakata-shi, Osaka (JP); Shinichi HORII, Hirakata-shi, Osaka (JP)

(73) Assignee: NIPPON PAINT AUTOMOTIVE COATINGS CO., LTD., Hirakata-shi, Osaka (JP)

(21) Appl. No.: 18/029,986

(22) PCT Filed: Oct. 4, 2021
(86) PCT No.: PCT/JP2021/036655

§ 371 Date: Apr. 3, 2023

(30) Foreign Application Priority Data
Oct. 5, 2020 (JP) 2020-168727

(51) Int. Cl. C09D 175/04; C09D 7/65; C09D 7/40; C09D 5/00

(52) U.S. Cl. CPC C09D 175/04; C09D 7/65; C09D 7/70; C09D 5/002

(57) ABSTRACT

The present invention provides a base coating composition capable of forming a base coating film superior in design property (e.g., unevenness of a luster pigment), adhesion, and water resistance while satisfying environmental considerations such as shortening of drying time, and also provides a coated article obtained from the base coating composition. The present invention provides a base coating composition comprising a pigment (A), a hydroxy group-containing acrylic resin (B), a blocked isocyanate compound (C), crosslinked polymer fine particles (D) insoluble and stably dispersed in a solution of the hydroxy group-containing acrylic resin (B), and an acrylic resin (E) having a weight average molecular weight different from that of the hydroxy group-containing acrylic resin (B), wherein the specific hydroxy group-containing acrylic resin (B) is used and a viscosity recovery rate is adjusted. The present invention also provides a coated article formed using a base coating composition.

### TECHNICAL FIELD

The present invention relates to a base coating composition and a coated article.

### BACKGROUND ART

Usually, for the purpose of imparting design, resistance, and the like, a base coating film is provided on an article to be coated, such as a base material to constitute an automobile, and a clear coating film is further provided on the base coating film. A base coating composition to form such a base coating film is a basic coating material that affects the design property of an article to be coated, and the base coating composition must satisfy various requirements such as consideration for the environment and consideration for increased ease of coating work. Base coating compositions are disclosed in, for example, Patent Literature 1 and Patent Literature 2.

### CITATIONS LIST

### Patent Literature

Patent Literature 1: JP-A-2008-138179
Patent Literature 2: JP-A-2010-82529

### SUMMARY OF INVENTION

### Technical Problems

As an environmental consideration, not a solvent-based base coating composition but an aqueous base coating composition has been studied, and Patent Literature 1 discloses an aqueous base coating composition. However, aqueous base coating compositions inevitably need energy to evaporate water for drying or curing, and have a large load on facilities.

In Patent Literature 2, not an aqueous base coating composition but a solvent-based base coating composition is used, and a 3-coat 1-bake system in which three layers (intermediate coating, base, and clear) are applied and then cured at one time is adopted to improve energy saving and equipment burden, thereby satisfying the environmental consideration.

However, a base coating composition is the most important coating material for determining the appearance of an article to be coated, in addition, since coating films exist also above and below a base coating film, the base coating composition is required for high control, and it is very difficult to incorporate environmental consideration into the base coating composition. Therefore, the coating materials of the prior art are not necessarily completed.

The present invention has been devised in view of the above circumstances, and an object of the present invention is to, while using a high-solid-content (or high-solid) solvent-based coating material, provide a base coating composition capable of forming a base coating film superior in design property (e.g., unevenness of a luster pigment), adhesion, and water resistance while satisfying environmental considerations such as shortening of drying time, and also provide a coated article obtained from the base coating composition.

### Solutions to Problems

The present invention provides the following modes.

[1]

A base coating composition comprising a pigment (A); a hydroxy group-containing acrylic resin (B); a blocked isocyanate compound (C); crosslinked polymer fine particles (D) insoluble and stably dispersed in a solution of the hydroxy group-containing acrylic resin (B); and an acrylic resin (E) having a weight average molecular weight different from that of the hydroxy group-containing acrylic resin (B), wherein the base coating composition has a solid content of 35% by mass or more; when, using a cone-plate viscometer, a viscosity V1 is measured at a shear of 0.1/sec at 23° C., then the shear is changed from 0.1/sec to 25000/sec and applied for 30 seconds, and subsequently a viscosity V2 is measured after the shear is returned to 0.1/sec and then applied for one second, a viscosity recovery rate V21V1, which is a ratio of V2 to V1, is 90% or more; the pigment (A) contains one or more pigment selected from coloring pigments and scaly pigments; the hydroxy group-containing acrylic resin (B) is a polymer of one or more monomers including a hydroxy group-containing monomer (b), wherein the hydroxy group-containing monomer (b) is a lactone-modified product of a monoester compound derived from (meth)acrylic acid with a dihydric alcohol having 2 or more and 8 or less carbon atoms, has a weight average molecular weight of 10000 or more and 20000 or less, has a glass transition temperature of 10° C. or higher and 40° C. or lower, and has a hydroxyl value of 10 mg KOH/g or more and 50 mg KOH/g or less; and the acrylic resin (E) has a weight average molecular weight of 3000 or more and 7500 or less.

[2]

The base coating composition of [1], wherein the hydroxy group-containing acrylic resin (B) is a polymer of the hydroxy group-containing monomer (b) and another monomer other than the hydroxy group-containing monomer (b), and the hydroxy group-containing monomer (b) accounts for 5% by mass or more and 20% by mass or less in a total of the hydroxy group-containing monomer (b) and the other monomer.

[3]

A coated article comprising: an article to be coated; and a base coating film formed from the base coating composition of [1] or [2].

[4]

The coated article of [3] comprising a multilayer coating film including a base coating film provided on the article to be coated and a clear coating film provided on the base coating film.

[5]

The coated article of [3] comprising a multilayer coating film including a base coating film provided on the article to be coated provided in advance with an intermediate coating film or a primer coating film, and a clear coating film provided on the base coating film.

### Advantageous Effects of Invention

In the present invention, in a base coating composition in which a hydroxy group-containing acrylic resin is crosslinked with a blocked isocyanate compound, an acrylic resin having a low weight average molecular weight different from that of the hydroxy group-containing acrylic resin and crosslinked polymer particles are incorporated and the shear viscosity of the resulting composition is specified, thereby making it possible to provide a base coating composition having superior orientation of an incorporated pigment (in particular, luster pigment) even at a high solid content and having superior adhesion to coating films located upper and below a base coating film. Since the base coating composition of the present invention has a high solid content, the base coating composition exhibits superior dryability during coating, and forms a coating film having a superior appearance without disturbing the incorporation of the luster pigment incorporated.

The base coating composition of the present invention also has superior adhesion to coating films present above and below the base coating composition, and provides a coating film having superior design property with few defects such as coating film peeling to an article to be coated.

### DESCRIPTION OF EMBODIMENTS

The base coating composition of the present invention comprises a pigment (A), a hydroxy group-containing acrylic resin (B), a blocked isocyanate compound (C), crosslinked polymer fine particles (D) insoluble and stably dispersed in the hydroxy group-containing acrylic resin (B), and an acrylic resin (E) having a weight average molecular weight different from that of the hydroxy group-containing acrylic resin (B), and is characterized in that the solid content of the base coating composition is a high solid content of 35% by mass or more, and when, using a cone-plate viscometer, a viscosity V1 is measured at a shear of 0.1/sec at 23° C., then the shear is changed from 0.1/sec to 25000/sec and applied for 30 seconds, and subsequently a viscosity V2 is measured after the shear is returned to 0.1/sec and then applied for one second, a viscosity recovery rate V2/V1, which is a ratio of V2 to V1, is 90% or more. Furthermore, it is required that: the pigment (A) contains one or more pigment selected from coloring pigments and scaly pigments; the hydroxy group-containing acrylic resin (B) is a polymer of one or more monomers including a hydroxy group-containing monomer (b), wherein the hydroxy group-containing monomer (b) is a lactone-modified product of a monoester compound derived from (meth)acrylic acid with a dihydric alcohol having 2 or more and 8 or less carbon atoms, has a weight average molecular weight of 10000 or more and 20000 or less, has a glass transition temperature of 10° C. or higher and 40° C. or lower, and has a hydroxyl value of 10 mg KOH/g or more and 50 mg KOH/g or less; and the acrylic resin (E) has a weight average molecular weight of 3000 or more and 7500 or less.

It has been found that by using a base coating composition meeting this requirement, it is possible to obtain a base coating film being superior in adhesion and water resistance and having a high design property with less unevenness of the coating film even when the base coating composition has a high solid content.

Hereinafter, details of a base coating composition and a coated article according to the embodiment of the present invention will be described.

[Base coating composition]

A base coating composition according to the embodiment of the present invention comprises a pigment (A), a hydroxy group-containing acrylic resin (B), a blocked isocyanate compound (C), crosslinked polymer fine particles (D) insoluble and stably dispersed in the hydroxy group-containing acrylic resin (B), and an acrylic resin (E) having a weight average molecular weight different from that of the hydroxy group-containing acrylic resin (B).

(1) Pigment (A)

The pigment (A) comprises one or more member selected from the group consisting of coloring pigments and scaly pigments.

Examples of the coloring pigments include organic coloring pigments such as azo chelate pigments, insoluble azo pigments, condensed azo pigments, diketopyrrolopyrrole pigments, benzimidazolone pigments, phthalocyanine pigments, indigo pigments, perinone pigments, perylene pigments, dioxane pigments, quinacridone pigments, isoindolinone pigments, and metal complex pigments; and inorganic coloring pigments such as chrome yellow, yellow iron oxide, red iron oxide, carbon black, and titanium dioxide.

Examples of the scaly pigment include metal flakes, metal oxide flakes, pearl pigments, and mica. Examples of the metal flake include aluminum, chromium, gold, silver, copper, brass, titanium, nickel, nickel chromium, and stainless steel. Examples of the metal oxide flake include oxides of metal flakes, for example, alumina and chromium oxide.

In a mode in which the base coating composition contains a scaly pigment, metallic luster can be imparted to a base coating film, and as described later, a base coating film that exhibits a more remarkable change in color tone depending on the angle at which the base coating film is observed, in other words, that has a high flip-flop property (hereinafter sometimes referred to as “FF property”) can be formed.

Further, in order to easily prevent a metal flake, a metal oxide flake, a pearl pigment, and the like from reacting with water to generate gas, metal coating, e.g. a coating of a metal compound such as molybdic acid, chromic acid, yttrium and a rare earth metal, or an organic polymer coating, e.g. a coating of an organic polymer prepared using a polymerizable monomer, may be formed on the metal flake, the metal oxide flake, and the pearl pigment. For example, the metal flake, the metal oxide flake, and the pearl pigment may have a coating containing silicon dioxide, zirconium oxide, aluminum oxide, chromium oxide, polymerized synthetic resins, vanadium oxides, molybdenum oxides and/or molybdenum peroxides, phosphates, phosphites, borates, chromates, and mixtures or combinations thereof. For example, in the case of using chromium oxide or the like, toxicity can be removed by using a chemically inactivated material.

The scaly pigment may contain a vapor-deposited metal pigment. Such scaly pigments are generally prepared by vapor depositing a metal thin film (metal oxide thin film) on a base film, peeling off the base film, and then pulverizing the vapor-deposited metal film to yield metal flakes (metal oxide flakes). As the metal material to be vapor-deposited, for example, the materials described for the metal flake and the metal oxide flake can be used. In this embodiment, the scaly pigment is preferably vapor-deposited aluminum pigment, vapor-deposited chromium pigment, vapor-deposited alumina pigment, or vapor-deposited chromium oxide pigment. As for also the vapor-deposited metal pigment, the above-described coating may be formed on the surface thereof, as necessary.

Examples of commercially available scaly pigments include METALURE (registered trademark) series, SILVERSHINE (registered trademark) series, HYDROSHINE (registered trademark) series, Liquid Black (registered trademark), PLISMATIC (registered trademark) series produced by ECKART, FD series, GX series and BS series produced by Asahi Kasei Chemicals Corporation, and 46 series and 63 series produced by Toyo Aluminium K.K. Two or more kinds of the pigment (A) may be used in combination.

The content of the pigment (A) is not particularly limited, and for example, the pigment concentration of the pigment (A), that is, the mass ratio of the pigment (A) to the resin solid of the base coating composition may be 1% by mass or more and 20% by mass or less. The resin solid of the base coating composition means a resin component, a blocked isocyanate compound (C), and other curing agents that can be contained.

The base coating composition may contain an extender pigment. Examples of the extender pigment include calcium carbonate, barium sulfate, clay, and talc.

When an extender pigment is used, a single extender pigment may be used or two or more extender pigments may be used in combination. When the base coating composition contains an extender pigment, the content of the extender pigment, for example, the mass ratio of the extender pigment to the resin solid of the base coating composition, may be 0.1% by mass or more and 20% by mass or less.

(2) Hydroxy Group-Containing Acrylic Resin (B)

The hydroxy group-containing acrylic resin (B) is a polymer of one or more monomers including a hydroxy group-containing monomer (b), and the hydroxy group-containing monomer (b) is a lactone-modified product of a monoester compound derived from (meth)acrylic acid and a dihydric alcohol having 2 or more and 8 or less carbon atoms. The hydroxy group-containing acrylic resin (B) has a weight average molecular weight of 10,000 or more and 20,000 or less, a glass transition temperature of 10° C. or higher and 40° C. or lower, and a hydroxyl value of 10 mg KOH/g or more and 50 mg KOH/g or less.

Owing to containing the hydroxy group-containing acrylic resin (B), the coating viscosity does not become excessively high even when the solid content of the base coating composition is as high as 35% by mass or more, so that unevenness of a coating film can be reduced. Furthermore, when the base coating composition contains a scaly pigment, the orientation of the scaly pigment is less likely to be disturbed, so that a superior FF property (flip-flop property: a property of the degree of brightness of a coating film surface to change depending on a viewing angle) can be obtained. The upper limit of the solid content of the base coating composition is not particularly limited, and may be, for example, 60% by mass.

Furthermore, since the hydroxy group-containing acrylic resin (B) is prepared through polymerization using a hydroxy group-containing monomer (b) that is a lactone-modified product of a monoester compound derived from (meth)acrylic acid and a dihydric alcohol having 2 or more and 8 or less carbon atoms, the hydroxy group-containing acrylic resin (B) has, in a side chain, a long chain structure having a hydroxy group. This makes it possible to enhance the reactivity with an isocyanate compound (C) that is a curing agent and also possible to enhance the adhesion between an article to be coated and a base coating film or the adhesion between an intermediate coating film or a primer coating film provided on the article to be coated and the base coating film. For example, when the article to be coated is made of plastic, the base coating composition according to the embodiment of the present invention can form a base coating film having good adhesion to the article without providing a primer coating film on the article.

The hydroxy group-containing acrylic resin (B) is obtained by polymerizing one or more monomers including the hydroxy group-containing monomer (b) in accordance with a conventional method.

Examples of the hydroxy group-containing monomer (b) include a lactone-modified product obtained by modifying a monoesterified product derived from (meth)acrylic acid and a dihydric alcohol having 2 or more and 8 or less carbon atoms, such as 2-hydroxyethyl (meth)acrylate, 2-hydroxypropyl (meth)acrylate, 3-hydroxypropyl (meth)acrylate, or 4-hydroxybutyl (meth)acrylate, with a lactone, such as ε-caprolactone.

In the present description, “(meth)acryl” means both acryl and methacryl.

The hydroxy group-containing acrylic resin (B) may be a polymer of the hydroxy group-containing monomer (b) and another monomer other than the hydroxy group-containing monomer (b). In this embodiment, the hydroxy group-containing acrylic resin (B) is obtained by polymerizing a monomer mixture of the hydroxy group-containing monomer (b) and the other monomer, and the hydroxy group-containing monomer (b) is preferably 5% by mass or more and 20% by mass or less in the total of the hydroxy group-containing monomer (b) and the other monomer.

Examples of the monomers other than the hydroxy group-containing monomer (b) include acid group-containing monomers such as acrylic acid, methacrylic acid, acrylic acid dimer, crotonic acid, 2-acryloyloxyethylphthalic acid, 2-acryloyloxyethylsuccinic acid, ω-carboxy-polycaprolactone mono(meth)acrylate, isocrotonic acid, α-hydro-ω-((1-oxo-2-propenyl)oxy) poly(oxy(l-oxo-1,6-hexanediyl)), maleic acid, fumaric acid, itaconic acid, 3-vinylsalicylic acid, 3-vinylacetylsalicylic acid, 2-acryloyloxyethyl acid phosphate, and 2-acrylamido-2-methylpropanesulfonic acid.

Examples of the monomer other than the hydroxy group-containing monomer (b) include (meth)acrylate esters (e.g., methyl (meth)acrylate, ethyl (meth)acrylate, n-propyl (meth)acrylate, n-butyl (meth)acrylate, isobutyl (meth)acrylate, t-butyl (meth)acrylate, 2-ethylhexyl (meth)acrylate, lauryl methacrylate, phenyl acrylate, isobornyl (meth)acrylate, cyclohexyl methacrylate, t-butylcyclohexyl (meth)acrylate, dicyclopentadienyl (meth)acrylate, and dihydrodicyclopentadienyl (meth)acrylate), polymerizable aromatic compounds (e.g., styrene, α-methylstyrene, vinyl ketone, t-butylstyrene, parachlorostyrene, and vinylnaphthalene), polymerizable nitriles (e.g., acrylonitrile and methacrylonitrile), α-olefins (e.g., ethylene and propylene), vinyl esters (e.g., vinyl acetate and vinyl propionate), and dienes (e.g., butadiene and isoprene). From the viewpoint of enhancing water resistance, styrene is preferably used.

Examples of the monomer other than the hydroxy group-containing monomer (b) further include hydroxyethyl (meth)acrylate, hydroxypropyl (meth)acrylate, hydroxybutyl (meth)acrylate, allyl alcohol, and methacryl alcohol.

As the hydroxy group-containing monomer (b), a single alcohol may be used or two or more alcohols may be used in combination. As the monomer other than the hydroxy group-containing monomer (b), a single monomer may be used or two or more monomers may be used in combination.

The weight average molecular weight of the hydroxy group-containing acrylic resin (B) may be, for example, 10,000 or more, and may be 20,000 or less.

The weight average molecular weight may be determined, for example, by gel permeation chromatography (GPC) using polystyrene as a standard.

The glass transition temperature of the hydroxy group-containing acrylic resin (B) may be, for example, 10° C. or higher, and may be 40° C. or lower.

The glass transition temperature may be one actually measured or calculated by a known method. For example, the glass transition temperature may be measured using a differential scanning calorimeter (DSC) in accordance with JIS K 7121.

The hydroxyl value of the hydroxy group-containing acrylic resin (B) may be, for example, 10 mg KOH/g or more, and may be, for example, 50 mg KOH/g or less. The acid value of the hydroxy group-containing acrylic resin (B) may be, for example, 0.2 mg KOH/g or more, and may be, for example, 20 mg KOH/g or less.

The hydroxyl value and the acid value may be those actually measured or calculated by a known method. For example, the hydroxyl value and the acid value may be measured in accordance with JIS K 0070:1992.

As the hydroxy group-containing acrylic resin (B), two or more resins may be used in combination. The content of the hydroxy group-containing acrylic resin (B) in the base coating composition is not particularly limited, and may be, for example, 30% by mass or more and 70% by mass or less, and may be 40% by mass or more, and may be 60% by mass or less, in the resin solid content of the base coating composition.

(3) Blocked isocyanate compound (C) By using the blocked isocyanate compound (C) together with the hydroxy group-containing acrylic resin (B), it is possible to enhance the adhesion between an article to be coated and a base coating film or the adhesion between an intermediate coating film or a primer coating film provided on an article to be coated and a base coating film. In addition, a base coating film is crosslinked, so that the physical properties of the base coating film are improved and the water-resisting performance is improved.

The blocked isocyanate compound (C) can be prepared by blocking a polyisocyanate with a blocking agent.

Examples of the polyisocyanate include aliphatic diisocyanates such as hexamethylene diisocyanate (including a trimer), pentamethylene diisocyanate, tetramethylene diisocyanate, and trimethylhexamethylene diisocyanate; alicyclic polyisocianates such as isophorone diisocyanate and 4,4′-methylenebis(cyclohexyl isocyanate); aromatic diisocyanates such as 4,4′-diphenylmethane diisocyanate, tolylene diisocyanate, and xylylene diisocyanate; and modified materials thereof (urethanized materials, materials modified with carbodiimide, uretdione, uretonimine, biuret and/or isocyanurate).

Examples of the blocking agent that is preferably be used include monohydric alkyl (or aromatic) alcohols such as n-butanol, n-hexyl alcohol, 2-ethylhexanol, lauryl alcohol, phenol carbinol, and methylphenyl carbinol; cellosolves such as ethylene glycol monohexyl ether and ethylene glycol mono-2-ethylhexyl ether; polyether-type both-ended dials such as polyethylene glycol, polypropylene glycol, and polytetramethylene ether glycol phenol; polyester-type both-ended polyols obtained from a diol such as ethylene glycol, propylene glycol, or 1,4-butanediol and a dicarboxylic acid such as oxalic acid, succinic acid, adipic acid, suberic acid, or sebacic acid; phenols such as para-t-butylphenol and cresol; oximes such as dimethyl ketoxime, methyl ethyl ketoxime, methyl isobutyl ketoxime, methyl amyl ketoxime, and cyclohexanone oxime; and lactams typified by ε-caprolactam and γ-butyrolactam. As the blocking agent, methyl diketone, methyl ketoester, and methyl diester compounds, which are active hydrogen compounds, for example, alkyl esters such as acetylacetone, ethyl acetoacetate, and diethyl malonate may be used. In addition, a blocked isocyanate formed from an imidazole compound or a pyrazole compound may be used.

The blocking ratio of the blocked isocyanate compound (C) is preferably 100%. This affords an advantage that the storage stability of the base coating composition is further improved.

As the blocked isocyanate compound (C), two or more compounds may be used in combination.

The content of the blocked isocyanate compound (C) is not particularly limited, but from the viewpoint of more appropriately accelerating a curing reaction, the ratio (NCO/OH) of the number of moles of the isocyanate groups of the blocked isocyanate compound (C) to the number of moles of the hydroxy groups of the hydroxy group-containing acrylic resin (B) may be 0.2/1.0 to 0.6/1.0, and is preferably 0.3/1.0 to 0.5/1.0.

The base coating composition may contain, as a curing agent other than the isocyanate compound (C), another curing agent such as an amino resin such as melamine resin, guanamine resin, or urea resin. When another curing agent other than the isocyanate compound (C) is contained, the content of the other curing agent is, for example, 10 parts by mass or more and 30 parts by mass or less, based on 100 parts by mass of the resin solid content of the base coating composition.

(4) Crosslinked Polymer Fine Particles (D)

The crosslinked polymer fine particles (D) are added as a viscosity modifier, and contribute to the adjustment of the viscosity described later. Usually, a coating material is reduced in viscosity by a shearing force applied during coating application, and thus the viscosity immediately after the coating application is lower than the viscosity before the coating application. For this reason, when the viscosity after application is low, the coating material runs down, which causes unevenness of a coating film. When the base coating composition according to the embodiment of the present invention contains the crosslinked polymer fine particles (D), the viscosity reduced during application can be quickly recovered and increased, the base coating composition applied to an article to be coated can be inhibited from sagging, and unevenness of a coating film can be reduced.

The crosslinked polymer fine particles (D) can be prepared by polymerizing a monomer mixture. The polymerization method may be any polymerization method as long as crosslinked fine particles can be obtained, and may be multistage polymerization. More specifically, emulsion polymerization is suitably used.

### Crosslinked Polymer Fine Particles (D) Obtained by Emulsion Polymerization

The crosslinked polymer fine particles (D) to be used in the present invention are obtained by forming an emulsion containing crosslinked polymer fine particles by emulsion polymerizing an ethylenically unsaturated monomer and a crosslinkable copolymerizable monomer in an aqueous medium by a known method followed by removal of water by solvent replacement, azeotropy, centrifugal separation, filtration, drying, or the like. The emulsion polymerization may be carried out using a known emulsifier and/or dispersant, but it is preferable to use an emulsifier having a zwitterionic group. When the crosslinked polymer fine particles (D) are added to a coating composition, the structural viscosity varies depending on the particle size of the crosslinked polymer fine particles. Therefore, it is important to obtain crosslinked polymer fine particles uniform in particle size. The use of an emulsifier having a zwitterionic group is preferable because this makes it easy to obtain crosslinked polymer fine particles uniform in particle size.

Examples of the ethylenically unsaturated monomer to be used for the preparation of the crosslinked polymer fine particles (D) include alkyl esters of acrylic acid or methacrylic acid such as methyl (meth)acrylate, ethyl (meth)acrylate, n-butyl (meth)acrylate, isobutyl (meth)acrylate, and 2-ethylhexyl (meth)acrylate, and other monomers having an ethylenically unsaturated bond that can be copolymerized with those alkyl esters, such as styrene, α-methylstyrene, vinyltoluene, t-butylstyrene, ethylene, propylene, vinyl acetate, vinyl propionate, acrylonitrile, methacrylonitrile, and dimethylaminoethyl (meth)acrylate. Two or more of these monomers may be used.

Crosslinkable copolymerizable monomers include a monomer having two or more radically polymerizable ethylenically unsaturated bonds in the molecule and/or two ethylenically unsaturated group-containing monomers that carry groups capable of reacting with each other, respectively.

Examples of the monomer having two or more radically polymerizable ethylenically unsaturated groups in the molecule include polymerizable unsaturated monocarboxylic acid esters of polyhydric alcohols, polymerizable unsaturated alcohol esters of polybasic acids, and aromatic compounds substituted with two or more vinyl groups, and examples thereof include the following compounds.

Ethylene glycol diacrylate, ethylene glycol dimethacrylate, triethylene glycol dimethacrylate, tetraethylene glycol dimethacrylate, 1,3-butylene glycol dimethacrylate, trimethylolpropane triacrylate, trimethylolpropane trimethacrylate, 1,4-butanediol diacrylate, neopentyl glycol diacrylate, 1,6-hexanediol diacrylate, pentaerythritol diacrylate, pentaerythritol triacrylate, pentaerythritol tetraacrylate, pentaerythritol dimethacrylate, pentaerythritol trimethacrylate, pentaerythritol tetramethacrylate, glycerol dimethacrylate, glycerol diacrylate, glycerol allyloxy dimethacrylate, 1,1,1-trishydroxymethylethane diacrylate, 1,1,1-trishydroxymethylethane triacrylate, 1,1,1-trishydroxymethylethane dimethacrylate, 1,1,1-trishydroxymethylethane trimethacrylate, 1,1,1-trishydroxymethylpropane diacrylate, 1,1,1-trishydroxymethylpropane triacrylate, 1,1,1-trishydroxymethylpropane dimethacrylate, 1,1,1-trishydroxymethylpropane trimethacrylate, triallyl cyanurate, triallyl isocyanurate, triallyl trimellitate, diallyl terephthalate, diallyl phthalate, and divinylbenzene.

Furthermore, as a monomer for the purpose of crosslinking, instead of the monomer having two or more radically polymerizable ethylenically unsaturated groups in the molecule or, as desired, together therewith, a monomer having two ethylenically unsaturated groups that carry groups capable of reacting with each other, respectively can also be used. Examples thereof include glycidyl group-containing ethylenically unsaturated monomers such as glycidyl methacrylate and glycidyl acrylate, and carboxyl group-containing ethylenically unsaturated monomers such as acrylic acid, methacrylic acid, and crotonic acid; and hydroxy group-containing ethylenically unsaturated monomers such as 2-hydroxyethyl acrylate, hydroxypropyl acrylate, 2-hydroxyethyl methacrylate, hydroxypropyl methacrylate, hydroxybutyl acrylate, hydroxybutyl methacrylate, allyl alcohol, and methallyl alcohol, and ethylenically unsaturated monomers having an isocyanate group such as vinyl isocyanate and isopropenyl isocyanate. However, in addition to these, any combination of two ethylenically unsaturated monomers that carry groups capable of reacting with each other, respectively, can be used.

The monomer constituting the crosslinked polymer fine particles (D) may contain a monomer having a functional group capable of reacting with a crosslinking agent. Examples thereof include carboxyl group-containing monomers such as acrylic acid, methacrylic acid, crotonic acid, itaconic acid, maleic acid, and fumaric acid; hydroxy group-containing monomers such as 2-hydroxyethyl acrylate, hydroxypropyl acrylate, 2-hydroxyethyl methacrylate, hydroxypropyl methacrylate, hydroxybutyl acrylate, hydroxybutyl methacrylate, allyl alcohol, and methacryl alcohol; and nitrogen-containing monomers such as acrylamide and methacrylamide.

### Polymerizable Crosslinked Particles (D) Prepared by Non-Aqueous Dispersion Polymerization

The monomer mixture to be used for the preparation of the crosslinked polymer fine particles (D) contains a radically polymerizable monomer. The monomer mixture may contain a radically polymerizable unsaturated monomer having a pendant side chain containing a higher unsaturated aliphatic group. When the monomer mixture contains a radically polymerizable unsaturated monomer having a pendant side chain containing a higher unsaturated aliphatic group, there is an advantage that crosslinked polymer fine particles can be suitably prepared.

Examples of the radically polymerizable unsaturated monomer having a pendant side chain containing a higher unsaturated aliphatic group include those obtained through a reaction of a higher unsaturated fatty acid with an ethylenically unsaturated glycidyl ester. As the higher unsaturated fatty acid, myristoleic acid, palmitoleic acid, oleic acid, linoleic acid, linolenic acid, ricinoleic acid, and the like can be used. Furthermore, drying oils having a non-conjugated double bond, such as linseed oil fatty acid, safflower oil fatty acid, soybean oil fatty acid, rice bran oil fatty acid, sesame oil fatty acid, castor oil fatty acid, dehydrated castor oil fatty acid, perilla oil fatty acid, hempseed oil fatty acid, cottonseed oil fatty acid, and tall oil fatty acid, semi-drying oil fatty acids, and the like can be used. The drying oils, semi-drying oil fatty acids, and the like include unsaturated fatty acids such as oleic acid, linoleic acid, linolenic acid, eleostearic acid, and ricinoleic acid. The average number of carbon atoms of the higher unsaturated aliphatic group is preferably 13 or more and 23 or less. A fatty acid having a conjugated double bond such as tung oil fatty acid may be used in combination in an amount of 30% by mass or less relative to the total saturated fatty acid. As the ethylenically unsaturated glycidyl ester, glycidyl acrylate, glycidyl methacrylate, methyl glycidyl acrylate, methyl glycidyl methacrylate, allyl glycidyl ether, methallyl glycidyl ether, and the like can be used. Among these, those obtained through a reaction of at least one selected from among oleic acid, linoleic acid, linolenic acid, safflower oil fatty acid, soybean oil fatty acid, castor oil fatty acid, dehydrated castor oil fatty acid, and tall oil fatty acid with glycidyl acrylate and/or glycidyl methacrylate are particularly preferable. Furthermore, as the radically polymerizable unsaturated monomer, those having an iodine value of 60 or more and 180 or less, particularly 70 or more and 150 or less are preferable.

Examples of other radically polymerizable unsaturated monomers other than the radically polymerizable unsaturated monomer having a pendant side chain containing a higher unsaturated aliphatic group contained in the monomer mixture include:
acrylate ester monomers such as methyl acrylate, ethyl acrylate, n-propyl acrylate, n-butyl acrylate, i-butyl acrylate, t-butyl acrylate, n-hexyl acrylate, n-octyl acrylate, i-octyl acrylate, 2-ethylhexyl acrylate, i-nonyl acrylate, stearyl acrylate, cyclohexyl acrylate, and benzyl acrylate;
methacrylate ester monomers such as methyl methacrylate, ethyl methacrylate, n-butyl methacrylate, i-butyl methacrylate, t-butyl methacrylate, n-hexyl methacrylate, n-octyl methacrylate, i-octyl methacrylate, 2-ethylhexyl methacrylate, i-nonyl methacrylate, n-dodecyl methacrylate, i-dodecyl methacrylate, stearyl methacrylate, cyclohexyl methacrylate, and benzyl methacrylate;
aromatic vinyl monomers such as styrene, vinyltoluene, and ethylvinylbenzene;
carboxyl group-containing monomers such as acrylic acid, methacrylic acid, itaconic acid, maleic acid, maleic anhydride, fumaric acid, crotonic acid, and citraconic acid;
amide group- or substituted amide group-containing monomers such as acrylamide, methacrylamide, N,N-dimethylacrylamide, N-methylacrylamide, and N-n-butoxymethylacrylamide;
hydroxy group-containing monomers such as 2-hydroxyethyl acrylate, 2-hydroxypropyl acrylate, 2-hydroxyethyl methacrylate, 2-hydroxypropyl methacrylate, allyl alcohol, and methallyl alcohol;
amino group- or substituted amino group-containing monomers such as aminoethyl acrylate, N,N-dimethylaminoethyl acrylate, N,N-diethylaminoethyl acrylate, N,N-dimethylaminoethyl methacrylate, and N,N-diethylaminoethyl methacrylate;
epoxy group-containing monomers such as glycidyl methacrylate, glycidyl acrylate, glycidyl allyl ether, glycidyl methallyl ether, and glycidyl vinyl ether;
mercapto group-containing monomers such as vinyl mercaptan and allyl mercaptan; and
monomers having two or more radically polymerizable unsaturated groups in one molecule such as (poly)ethylene glycol di(meth)acrylate, neopentyl glycol di(meth)acrylate, trimethylolpropane tri(meth)acrylate, allyl (meth)acrylate, triallyl cyanurate, triallyl isocyanurate, diallyl phthalate, and divinylbenzene.

Among the other radically polymerizable unsaturated monomers, one or more members selected from the group consisting of:
acrylate ester monomers (preferably, ethyl acrylate, n-butyl acrylate, and the like), methacrylate ester monomers (preferably, methyl methacrylate, n-butyl methacrylate, and the like),
carboxyl group-containing monomers (preferably, acrylic acid, methacrylic acid, co-carboxy-polycaprolactone monoacrylate, and the like), and substituted amino group-containing monomers (preferably, N,N-di-lower alkylamino-lower alkyl (meth)acrylate such as N,N-dimethylaminoethyl acrylate or N,N-diethylaminoethyl methacrylate)
   are preferably contained.

The amount of the radically polymerizable unsaturated monomer having a pendant side chain containing a higher unsaturated aliphatic group contained in the monomer mixture is preferably in a range of 0.5 parts by mass or more and 30 parts by mass or less, and more preferably in a range of 5 parts by mass or more and 15 parts by mass or less, based on 100 parts by mass of the total amount of the monomer mixture. The total amount of the acrylate ester monomer and the methacrylate ester monomer contained in the monomer mixture is preferably in a range of 50 parts by mass or more and 90 parts by mass or less based on 100 parts by mass of the total amount of the monomer mixture. The amount of the carboxyl group-containing monomer contained in the monomer mixture is preferably in the range of 10 parts by mass or less. Furthermore, the amount of the substituted amino group-containing monomer contained in the monomer mixture is preferably in a range of 10 parts by mass or less. When the crosslinked polymer fine particles (D) of the present invention are prepared by multistage polymerization, the amount of the monomers contained in the monomer mixture is the total of the amount of the monomer used in each polymerization.

The preparation of the crosslinked polymer fine particles (D) can be carried out with appropriate choice of polymerization conditions ordinarily used by those skilled in the art depending on the type and amount of the monomers to be used. For example, it is preferable to polymerize the monomer mixture such that the weight average molecular weight is made to fall within the range described later by heating and reacting the monomer mixture for several hours under stirring in a nitrogen stream or at a reflux temperature of an organic solvent using an appropriate polymerization initiator and a chain transfer agent used as necessary. The polymerization temperature is generally 30° C. or higher and 180° C. or lower, and preferably 60° C. or higher and 150° C. or lower.

Examples of the organic solvent to be used in the polymerization include:
aliphatic or alicyclic hydrocarbon solvents such as cyclohexane, methylcyclohexane, cycloheptane, methylcycloheptane “LAWS”, “Mineral Spirit EC”, “SHELLZOL 71”, “VM&P Naphtha”, “Shell TS28 solvent” [manufactured by Shell], “ISOPAR C”, “ISOPAR E”, “ISOPAR G”, “ISOPAR H”, “ISOPAR M”, “Naphtha 3”, “Naphtha 5”, “Naphtha 6”, “Solvent 7” (manufactured by Exxon Chemical Co.), “IP Solvent 1016”, “IP Solvent 1620”, “IP Solvent 2028”, “IP Solvent 2835” [manufactured by Idemitsu Kosan Co., Ltd.], “WHITE ZOL” [manufactured by Japan Energy Corporation], “Mitsubishi Mineral Turpentine”, “Diamond Solvent”, “Pegasol AN-45”, and “Pegasol 3040” [manufactured by JXTG Energy Corporation];
aromatic hydrocarbon-based organic solvents such as benzene, toluene, ethylbenzene, propylbenzene, t-butylbenzene, o-xylene, m-xylene, p-xylene, tetralin, decalin, “Solvesso 100” (manufactured by Exxon Chemical Co.), and “Solvesso 150” (manufactured by Exxon Chemical Co.);
ketone-based organic solvents such as acetone, acetylacetone, methyl ethyl ketone, methyl-1-butyl ketone, methyl amyl ketone, and cyclohexanone;
ester-based organic solvents such as methyl acetate, ethyl acetate, n-butyl acetate, and aluminum acetate;
cellosolve-based organic solvents such as methyl cellosolve, ethyl cellosolve, n-propyl cellosolve, i-propyl cellosolve, n-butyl cellosolve, i-butyl cellosolve, i-amyl cellosolve, phenyl cellosolve, and benzyl cellosolve; and
carbitol-based organic solvents such as methyl carbitol, ethyl carbitol, n-propyl carbitol, i-propyl carbitol, n-butyl carbitol, i-butyl carbitol, i-amyl carbitol, phenyl carbitol, and benzyl carbitol.

Examples of the polymerization initiator include organic peroxides such as benzoyl peroxide, lauroyl peroxide, caproyl peroxide, di-i-propyl peroxydicarbonate, di-2-ethylhexyl peroxydicarbonate, and t-butyl peroxypivalate; and azo compounds such as 2,2′-azobis-i-butylnitrile, 2,2′-azobis-2,4-dimethylvaleronitrile, and 2,2′-azobis-4-methoxy-2,4-dimethylvaleronitrile. These may be used singly or two or more thereof may be used in combination. The amount of the polymerization initiator used is generally preferably 0.5 parts by mass or more and 15 parts by mass or less, and more preferably 2 parts by mass or more and 8 parts by mass or less, based on 100 parts by mass of the total amount of the monomers.

When the crosslinked polymer fine particles (D) of the present invention are prepared by multistage polymerization, the preferred range of the amount of the polymerization initiator used may be applied to each polymerization.

In the case of subjecting a monomer mixture to two-stage polymerization in the preparation of the crosslinked polymer fine particles (D), a monomer mixture containing a radically polymerizable unsaturated monomer having a pendant side chain containing a higher unsaturated aliphatic group may be copolymerized and form a soluble part in a first polymerization stage, and then a monomer mixture free from a radically polymerizable unsaturated monomer having a pendant side chain containing a higher unsaturated aliphatic group or a monomer mixture containing a radically polymerizable unsaturated monomer having a pendant side chain containing a higher unsaturated aliphatic group may be copolymerized and form a grain part.

When the crosslinked polymer fine particles (D) have, for example, a soluble part and a grain part, the weight average molecular weight of the soluble part may be 15000 or more and 100,000 or less, and the grain part is preferably crosslinked by a monomer having two or more polymerizable unsaturated groups.

The weight average molecular weight may be determined, for example, by gel permeation chromatography (GPC) using polystyrene as a standard.

When the crosslinked polymer fine particles (D) have a soluble part and a grain part, the mass ratio of the soluble part to the grain part is preferably in the range of soluble part:grain part=20:80 to 80:20, and more preferably in the range of 30:70 to 70:30.

Another example of the preparation of the crosslinked polymer fine particles (D) is an example in which a monomer mixture free from a radically polymerizable unsaturated monomer having a pendant side chain containing a higher unsaturated aliphatic group is polymerized, and then a pendant side chain containing a higher unsaturated aliphatic group is introduced into the obtained copolymer. Specifically, for example, a monomer mixture containing an alkylene group-containing monomer is polymerized, and then a carboxyl group of a higher unsaturated fatty acid is reacted with an alkylene group of the obtained copolymer, whereby a pendant side chain containing a higher unsaturated aliphatic group can be introduced.

The blending amount of the crosslinked polymer fine particles (D) in the base coating composition is generally 5 to 40 parts by mass, and preferably 10 to 30 parts by mass, based on 100 parts by mass of the total solid content of the hydroxy group-containing acrylic resin (B), the blocked isocyanate compound (C), and the acrylic resin (E). If the blending amount of the crosslinked polymer fine particles (D) is excessively small, an increased ease of sagging of the base coating composition is afforded and, in the case of wet-on-wet coating, the permeation into an underlayer coating composition increases, so that the initial purpose is not achieved. On the other hand, if the blending amount is excessively large, the coating film performance is deteriorated and the smoothness of the coating is impaired, so that a highly finished appearance cannot be obtained.

Examples of commercially available products of the crosslinked polymer fine particles (D) include Setalux 1801, 1850, SA-50, and 53 (manufactured by Allnex GMBH).

(5) Acrylic resin (E) The base coating composition comprises an acrylic resin (E) having a weight average molecular weight of 3000 or more and 7500 or less. Owing to this, the viscosity of the base coating composition can be more easily adjusted.

The acrylic resin (E) can be obtained by polymerizing an α,β-ethylenically unsaturated monomer, and for example, the α,β-ethylenically unsaturated monomer described above for the hydroxy group-containing acrylic resin (B), or the like may be used.

The weight average molecular weight of the acrylic resin (E) is preferably 3500 or more, more preferably 4000 or more, and preferably 6500 or less, more preferably 5500 or less.

The weight average molecular weight may be determined, for example, by gel permeation chromatography (GPC) using polystyrene as a standard.

The hydroxyl value of the acrylic resin (E) may be, for example, 40 mg KOH/g or more. The acid value of the acrylic resin (E), for example, may be 0.1 mg KOH/g or more, and may be 20 mg KOH/g or less.

The hydroxyl value and the acid value may be those actually measured or calculated by a known method. For example, the hydroxyl value and the acid value may be measured in accordance with JIS K 0070:1992.

As the acrylic resin (E), two or more resins may be used in combination.

When the acrylic resin (E) is contained, the content of the acrylic resin (E) is not particularly limited, and may be, for example, 10% by mass or more and 50% by mass or less in the resin solid content of the base coating composition. If the blending amount of the acrylic resin (E) is excessively small, the viscosity of the coating material increases, and adverse effects occur during coating application. If the amount of the acrylic resin (E) is excessively large, the viscosity decreases, but the physical properties of a coating film deteriorate, leading to deterioration of adhesion and water resistance.

(6) Base Coating Composition

The base coating composition may contain an organic solvent.

Examples of such an organic solvent include ketones such as acetone, methyl ethyl ketone, methyl isobutyl ketone, and methyl amyl ketone; esters such as ethyl acetate, butyl acetate, amyl acetate, methyl benzoate, ethyl ethoxypropionate, ethyl propionate, and methyl propionate; ethers such as tetrahydrofuran, dioxane, and dimethoxyethane; glycol ethers such as ethylene glycol monomethyl ether, ethylene glycol monoethyl ether, diethylene glycol monomethyl ether, propylene glycol monomethyl ether acetate, and 3-methoxybutyl acetate; and aromatic hydrocarbons and aliphatic hydrocarbons.

The base coating composition of the present invention may comprise a curing catalyst, a viscosity modifier other than the crosslinked polymer fine particles (D), an antifoaming agent, an ultraviolet absorber, a light stabilizer (for example, a hindered amine), an antioxidant, a surface conditioning agent, a film-forming assistant, a rust inhibitor, and the like.

The method for producing the base coating composition is not particularly limited, and methods known in the art such as stirring, kneading, or dispersing the above-described materials using a disper, a homogenizer, a roll, a sand grinding mill, a kneader, or the like can be used.

The base coating composition of the present invention is characterized in that when, using a cone-plate viscometer, a viscosity V1 is measured at a shear of 0.1/sec at 23° C., then the shear is changed from 0.1/sec to 25000/sec and applied for 30 seconds, and subsequently a viscosity V2 is measured after the shear is returned to 0.1/sec and then applied for one second, a viscosity recovery rate V2/V1, which is a ratio of V2 to V1, is 90% or more. The higher the viscosity recovery rate V2/V1, the more preferable it is. The viscosity recovery rate represents the ratio of the viscosity at a weak shear point and the viscosity at a strong shear point, and a high viscosity recovery indicates that the viscosity is recovered immediately even just after coating application. The base coating composition of the present invention rapidly recovers viscosity even just after coating application.

### [Coated Article]

A coated article according to the embodiment of the present invention comprises: an article to be coated; and a base coating film formed from a base coating composition according to the embodiment of the present invention.

The coated article according to the embodiment of the present invention may comprise a multilayer coating film including an intermediate coating film or a primer coating film provided on the article to be coated, a base coating film provided on the intermediate coating film or the primer coating film, and a clear coating film provided on the base coating film.

In one mode, the coated article according to the embodiment of the present invention may have no intermediate coating film or no primer coating film, and the base coating film may be provided on the article to be coated. That is, in this mode, the coated article according to the embodiment of the present invention may comprise a multilayer coating film including a base coating film provided on the article to be coated and a clear coating film provided on the base coating film.

For example, when the article to be coated is made of plastic, the base coating composition according to the embodiment of the present invention can form a base coating film having good adhesion to the article without providing a primer coating film on the article.

(1) Article to be Coated

The article to be coated is not particularly limited, and examples thereof include a metal substrate, a plastic substrate, and foams thereof.

Examples of the metal substrate include metals such as iron, steel, copper, aluminum, tin, and zinc, and alloys containing such metals. Specific examples of the metal substrate include automobile bodies such as passenger cars, trucks, motorcycles, and buses, and parts for automobile bodies. It is preferable that such a metal substrate has an electrodeposition coating film formed thereon in advance. The metal substrate may have been subjected to a chemical conversion treatment (for example, zinc phosphate chemical conversion treatment and zirconium chemical conversion treatment), as necessary, before the formation of the electrodeposition coating film.

Examples of the plastic substrate include polypropylene resin, polycarbonate resin, urethane resin, polyester resin, polystyrene resin, ABS resin, vinyl chloride resin, and polyamide resin. Specific examples of the plastic substrate include automobile parts such as spoilers, bumpers, mirror covers, grills, and doorknobs. These plastic substrates are preferably those having been degreased with a solvent such as petroleum benzine or isopropanol or washed with pure water and/or a neutral detergent.

(2) Intermediate Coating Film, Primer Coating Film

When the article to be coated is a metal substrate, an intermediate coating film may be provided on the metal substrate on which electrodeposition coating is formed. When the article to be coated is a plastic substrate, a primer coating film may be provided on the plastic substrate.

The intermediate coating film and the primer coating film are not particularly limited, and may be formed using, for example, an intermediate coating composition or a primer coating composition comprising a coating film-forming resin and, as necessary, a curing agent and the like.

(3) Clear Coating Film

A clear coating film may be provided on the base coating film. The clear coating film is not particularly limited, and may be formed using a clear coating composition comprising a coating film-forming resin and, as necessary, a curing agent and the like. The clear coating film may contain a coloring component. The form of the clear coating composition is not particularly limited, but a solvent type is preferable.

From the viewpoint of transparency or resistance to acid etching, preferable examples of the solvent-type clear coating composition include those containing, as a coating film-forming resin, a combination of an acrylic resin and/or a polyester resin with an amino resin and/or an isocyanate, or an acrylic resin and/or a polyester resin with a carboxylic acid/epoxy curing system. Further, a two-pack clear containing an isocyanate as a crosslinking agent is more preferable. In particular, the isocyanate of the clear penetrates into a colored base coating film layer and is cured to form a multilayer coating film having superior water resistance.

Examples of an aqueous-type clear coating composition include that containing a water-borne resin prepared by neutralizing, with a base, a coating film-forming resin contained in a composition cited as an example of a solvent-type clear coating composition. The neutralization may be carried out before or after polymerization by adding a tertiary amine such as dimethylethanolamine and triethylamine.

The clear coating composition may further contain a viscosity controlling agent. Examples of the viscosity controlling agent include crosslinked or non-crosslinked resin particles, polyamide-based materials such as a swelling dispersion of aliphatic acid amide, amide-based aliphatic acid, and phosphate salts of long-chain polyaminoamide; and polyethylene-based materials such as a colloidal swelling dispersion of polyethylene oxide; organic bentonite-based materials such as organic acid smectite clay and montmorillonite.

The method for producing the coated article is not particularly limited, and for example, the coated article can be produced by the method for producing the coated article according to the embodiment of the present invention described below.

### [Method for Producing Coated Article]

The base coating composition of the present invention is applied to an article to be coated by a coating method similar to that of ordinary base coating materials. The base coating composition is applied onto an article to be coated provided with an intermediate coating film or a primer coating film. In addition, a clear coating material is applied onto the base coating film to form a clear coating film. The method for forming a coating film may be a commonly used method. For example, uncured coating films, which are called wet-on-wet, are formed through application using a spray applicator, and then two or three layers are cured simultaneously.

The coating methods for the intermediate coating composition, the primer coating composition, the base aqueous coating composition, and the clear coating composition are not particularly limited. According to the type of the article to be coated, a coating method commonly used in the coating field, for example, multi-stage coating or one-stage coating by air spray coating, bell coating, or air electrostatic spray coating, or a coating method in which air electrostatic spray coating is combined with a rotary atomization type electrostatic applicator, which is called a metallic bell, may be used.

Examples of the heating device to be used to heat and cure uncured coating films include a drying furnace using a heating source such as hot air, electricity, gas, or infrared rays. It is preferable to use a drying furnace in which two or more of these heating sources are used in combination because the drying time is shortened.

The coated article according to the embodiment of the present invention can also be produced by heating and curing a coating film every time each coating composition is applied, thereby sequentially forming an upper coating film. In addition, the coated article according to the embodiment of the present invention can be produced in a mode in which the step of forming an intermediate coating film and a primer coating film is omitted and neither an intermediate coating film nor a primer coating film is included.

### EXAMPLES

Hereafter, the present invention will be described in detail by way of examples, but the present invention is not limited by the examples at all. In the examples, “parts” and “%” are on a mass basis unless otherwise indicated.

### (Production Example 1) Production of Hydroxy Group-Containing Acrylic Resin (B-1)

A reactor equipped with a stirring blade, a thermometer, a dropping device, a temperature controller, a nitrogen gas inlet, and a cooling tube was charged with 57 parts of butyl acetate, and the temperature was raised to 120° C. under stirring while nitrogen gas was introduced. Next, a mixture of 0.5 parts of methacrylic acid, 53.1 parts of 2-ethylhexyl methacrylate, 18.1 parts of methyl methacrylate, 15.0 parts of styrene, and 13.3 parts of lactone-modified 2-hydroxyethyl methacrylate and a solution prepared by dissolving 2.0 parts of t-butyl peroxy-2-ethylhexanate in 5 parts of butyl acetate were added dropwise to the reactor over 3 hours. After completion of the dropwise addition, the mixture was aged for 1 hour, a solution prepared by dissolving 0.2 parts of t-butyl peroxy-2-ethylhexanate in 5 parts of butyl acetate was further added dropwise into the reactor over 1 hour, and the resulting mixture was aged for 2 hours while being maintained at 120° C. to complete the reaction. The obtained hydroxy group-containing resin had a nonvolatile content of 60% and a weight average molecular weight of 14500. The resin had a glass transition temperature of 20° C. and a hydroxyl value of 30 mg KOH/g. In Table 1, the blended monomer components, the characteristic values, the amounts of the polymerization initiator (t-butyl peroxy-2-ethylhexanate) in the first stage and the second stage, and the types of hydroxy groups (lactone-modified or not lactone-modified) are shown.

### (Production Examples 2 to 10) Production of Hydroxy Group-Containing Acrylic Resins (B-2 to B-10)

In the same reactor as in Production Example B-1, hydroxy group-containing acrylic resins of Production Examples B-2 to B-10 were obtained by the same operation with the formulations shown in Table 1. In Table 1, the characteristic values and the like of the obtained hydroxy group-containing acrylic resins (B-2 to B-10) are also shown in Table 1.

TABLE 1

| Resin production example | | B-1 | B-2 | B-3 | B-4 | B-5 | B-6 | B-7 | B-8 | B-9 | B-10 |
|---|---|---|---|---|---|---|---|---|---|---|---|
| Hydroxyl value (mg KOH/g) | | 30 | 50 | 20 | 20 | 40 | 30 | 30 | 5 | 70 | 30 |
| Glass transition temperature Tg (° C.: calculated) | | 20 | 25 | 10 | 20 | 20 | −8 | 45 | 20 | 20 | 20 |
| Monomer | Lactone-modified 2-hydroxyethyl | 13.3 | 20 | 8.9 | 8.9 | 15 | 13 | 13 | 2.2 | 31 | — |
| | methacrylate | | | | | | | | | | |
| | 2-Hydroxyethyl methacrylate | — | 1.2 | — | — | 1.5 | 0.2 | 0.2 | — | — | 7 |
| | Methyl methacrylate | 18.1 | 22.4 | 8 | 18.5 | 17.4 | 1.6 | 41.4 | 18.6 | 17.7 | 13.9 |
| | 2-Ethylhexyl methacrylate | 53.1 | 41.1 | 67.8 | 57.3 | 50.8 | 84.9 | 30.1 | 63.9 | 35.8 | 63.6 |
| | Styrene | 15 | 15 | 15 | 15 | 15 | 0 | 15 | 15 | 15 | 15 |
| | Methacrylic acid | 0.5 | 0.3 | 0.3 | 0.3 | 0.3 | 0.3 | 0.3 | 0.3 | 0.5 | 0.5 |
| | Total | 100 | 100 | 100 | 100 | 100 | 100 | 100 | 100 | 100 | 100 |
| Solvent, total | | 67 | 67 | 67 | 67 | 67 | 67 | 67 | 67 | 67 | 67 |
| Polymerization | First stage | 2 | 2.5 | 1.8 | 0.8 | 8 | 2 | 2 | 2 | 2 | 2 |
| initiator | Second stage | 0.2 | 0.2 | 0.2 | 0.2 | 0.2 | 0.2 | 0.2 | 0.2 | 0.2 | 0.2 |

| | | | | | | | | | | |
|---|---|---|---|---|---|---|---|---|---|---|
| Weight average molecular weight | 14500 | 10500 | 18900 | 28200 | 5500 | 14800 | 14300 | 14500 | 14300 | 14400 |
| Type of hydroxy group | Lactone | Lactone | Lactone | Lactone | Lactone | Lactone | Lactone | Lactone | Lactone | No |
| | | | | | | | | | | Lactone |

### (Production Examples 11 to 13) Production of Acrylic Resins (E-1 to E-3)

In the same reactor as in Production Example B-1 described above, acrylic resins (E-1 to E-3) were obtained by the same operation with the formulations shown in Table 2, and the characteristic values (weight average molecular weight, heating residue, amounts of polymerization initiator in first stage and second stage) thereof were shown in Table 2.

TABLE 2

| | | Resin production example | | |
|---|---|---|---|---|
| | | E-1 | E-2 | E-3 |
| Monomer | 2-Hydroxyethyl acrylate | 16.6 | 16.6 | 16.6 |
| | 2-Ethylhexyl acrylate | 48.6 | 48.6 | 48.6 |
| | Methyl methacrylate | 33.6 | 33.6 | 33.6 |
| | Methacrylic acid | 1.2 | 1.2 | 1.2 |
| | Total | 100 | 100 | 100 |
| Solvent, total | | 67 | 67 | 67 |
| Polymer- | First stage (t-butyl peroxide) | 10 | 20 | 3 |
| ization | Second stage (2-ethyl- | 0.2 | 0.2 | 0.2 |
| initiator | hexanate) | | | |

| | | | |
|---|---|---|---|
| Weight average molecular weight | 4500 | 2000 | 9500 |

### Reference Example 1

### Method for Producing Polyester Resin Having Zwitterionic Group

A 2 Q flask equipped with a stirrer, a nitrogen inlet tube, a temperature controller, a condenser, and a decanter was charged with 134 parts of bishydroxyethyltaurine, 130 parts of neopentyl glycol, 236 parts of azelaic acid, 186 parts of phthalic anhydride, and 27 parts of xylene, and the temperature is raised. Water produced through the reaction was removed azeotropically with xylene. The temperature is brought to 190° C. over about 2 hours from the start of refluxing, and stirring and dehydration were continued until the oxidation corresponding to the carboxylic acid reached 145, and then the mixture is cooled to 140° C.

Subsequently, the temperature is maintained at 140° C., and 314 parts of “CARDURA E 10” (glycidyl ester of versatic acid manufactured by Shell) is added dropwise over 30 minutes, then stirring is continued for 2 hours to complete the reaction. The resulting polyester resin had an acid value of 59, a hydroxyl value of 90, and Mn of 1054.

### (Production Example 14) Production Example of Crosslinked Polymer Fine Particles D-1

A 1 L reaction vessel equipped with a stirrer, a cooler, and a temperature controller is charged with 281 parts of deionized water, 30 parts of the polyester resin obtained in Reference Example 1, and 3 parts of dimethylethanolamine, and dissolved the mixture while the stirring temperature is maintained at 80′C, and then a solution prepared by dissolving 1.0 part of azobiscyanovaleric acid in 45 parts of deionized water and 0.9 parts of dimethylethanolamine is added thereto. Subsequently, a mixed solution of 30 parts of n-butyl acrylate, 70 parts of styrene, and 60 parts of ethylene glycol dimethacrylate is added dropwise over 60 minutes. After the dropwise addition, a solution prepared by dissolving 0.5 parts of azobiscyanovaleric acid in 15 parts of deionized water and 0.4 parts of dimethylethanolamine was further added, and the mixture was further continuously stirred at 80° C. for 2 hours to afford an emulsion having a nonvolatile content of 40% and a particle size of 0.12 μm. This emulsion was spray-dried to afford crosslinked polymer fine particles.

The crosslinked polymer fine particles were added to a solvent prepared by mixing methyl amyl ketone and xylene in a weight ratio of 1:1, and then adjusted to have a heating residue of 40% using an ultrasonic disperser, thereby affording a stable dispersion of crosslinked polymer particles.

### (Production Example 15) Production Example of Crosslinked Polymer Fine Particles D-2

An emulsion having a particle size of 0.20 μm was obtained in the same apparatus as in the Production Example described above except for using 5 parts of Na, di(2-ethylhexyl) sulfosuccinate in place of the polyester resin obtained in Reference Example 1. Similarly, this emulsion was spray-dried, ultrasonically dispersed in a mixed solvent, and adjusted to have a heating residue of 50%.

### Examples 1 to 5 and Comparative Examples 1 to 12

Starting materials were blended with compositions (coloring base coating material formulations) shown in the following Tables 3 and 4 and stirred to afford base coating compositions of Examples 1 to 5 and Comparative Examples 1 to 12. The compositions in the tables are expressed in the unit of part(s) by mass, and are amounts in terms of a solid content excluding an organic solvent. The amount of the crosslinked polymer fine particles (D) represents the amount based on 100 parts by mass of the hydroxy group-containing acrylic resin (B), the blocked isocyanate compound (C), and the acrylic resin (E) in total.

### (Preparation of Coating Material)

The coating materials of Examples 1 to 5 and Comparative Examples 1 to 12 are adjusted to have a viscosity in a No. 4 Ford cup of 13 seconds in a state with a coating material temperature of 20° C. using methyl amyl ketone/Solvesso 100=1/1 (weight ratio) as a dilution thinner. At that time, a coating material having a nonvolatile content of less than 35% was evaluated as x and a coating material having a nonvolatile content of 35% or more was evaluated as o. Boxes for the solid content at the time of coating are provided in Tables 3 and 4, and o or x was entered in each of the boxes. For coating materials having a nonvolatile content of less than 35%, other items were not evaluated.

(Preparation of Coated Article)

The base coating material of Example 1 was spray-coated (dry film thickness: 25 μm) on a surface of an ABS resin base material (70 mm×150 mm×3 mm) wiped with isopropyl alcohol using a spray gun “WIDER-71” (manufactured by ANEST IWATA Corporation) in an environment of 25° C./70% relative humidity (RH), and set at room temperature for 5 minutes. A clear coating composition (mixture of R-2550-1 and a curing agent H-2550 manufactured by Nippon Paint Automotive Coatings Co., Ltd.) was spray-coated (dry film thickness: 25 μm) thereon under application conditions (gun distance: 200 mm, gun speed: 700 mm/s, rotation speed: 25000 rpm, shaping air pressure: 0.07 MPa) using ROBOBEL 951. Then, after setting for 10 minutes, followed by drying at 80° C. for 30 minutes, the coated article of Example 1 was prepared.

Coated articles of Examples 2 to 5 and Comparative Examples 1 to 12 were obtained in the same manner as in Example 1 except that the base coating compositions of Examples 2 to 5 and Comparative Examples 1 to 12 shown in Tables 3 and 4 were used.

Using the base coating compositions and the coated articles obtained, unevenness (unevenness of coating film), adhesion, water resistance, coating film hardness, viscosity recovery rate, and flip-flop property (FF property) were evaluated in the following manner. The results are shown in Tables 3 and 4.

### (Unevenness of Coating Film)

The test panel obtained under the conditions described above was visually observed from an angle of 25 degrees on the front and an angle of 75 degrees on the diagonal, and the orientation of a pigment was observed.

The evaluation criteria are as follows, and o was regarded as pass and x was regarded as fail.
o: The orientation looks uniform at both of the angles.
x: The orientation looks non-uniform at both or one of the angles.

### (Adhesion)

The coating film of a test piece obtained from a coated article was subjected to a cross-cut CELLOTAPE (registered trademark) peeling test in accordance with JIS K 5600-5-6:1999. 100 cross-cuts 2 mm on each side were prepared, a cellophane tape peeling test was performed, and the number of cross-cuts not peeled off was counted.

The evaluation criteria are as follows, and o was regarded as pass and x was regarded as fail.
o: 0/100 (not peeled)
x: 1/100 to 100/100 (peeled)

### (Water Resistance)

A test piece obtained from a coated article was immersed in a water-resistant bath at 40° C. for 240 hours. After completion of the immersion, the coating film of the test piece taken out from the water-resistant bath was subjected to a cross-cut CELLOTAPE (registered trademark) peeling test and appearance observation in accordance with JIS K 5600-5-6:1999 within 1 hour after being taken out. 100 cross-cuts 2 mm on each side were prepared, a cellophane tape peeling test was performed, and the number of cross-cuts not peeled off was counted. In addition, as to the appearance, whether there was any abnormality such as blister was examined.

The evaluation criteria are as follows, and o was regarded as pass and x was regarded as fail.
o: 0/100 (not peeled), and here was no appearance abnormality.
Δ: 0/100 (not peeled), there was appearance abnormality.
x: 1/100 to 100/100 (peeled), irrelevant to appearance abnormality.

### (Coating Film Hardness)

The coated plate obtained above was allowed to stand at room temperature for 5 days, and then pencil scratch hardness was measured. The pencil used was a Mitsubishi UNI pencil for a scratch value test. In the measurement operation, the coated plate was placed and fixed on a horizontal table. With the pencil held such that the angle between the coated plate and the pencil with the lead thereof exposed in a cylindrical shape was 45 degrees and with the lead pressed against the coated plate as strongly as possible with the pencil prevented from breaking, the pencil was pushed forward at a speed of about 1 cm/sec to scratch the coating surface. This operation was carried out five times with pencils having the same concentration, and a set in which scratches or tears occurred twice or more and less than twice was found with respect to two grades of pencil whose concentration symbols were next to each other, and the concentration symbol of the pencils with which scratches or tears occurred less than twice was defined as the pencil hardness of the coating film.

Judgment criteria are as follows.
HB or more: o (good)
B or less: x (poor)

### (Viscosity Recovery Rate [%])

Using a cone-plate viscometer “DHR-3” manufactured by TA Instruments, the viscosity V1 was measured at a shear of 0.1/sec at 23° C., then the shear was changed from 0.1/sec to 25000/sec and applied for 30 seconds, and subsequently the viscosity V2 was measured after the shear was returned to 0.1/sec and then applied for one second. From the measured V1 and V2, the viscosity recovery rate V2V1 [%] was calculated.

The evaluation criteria are as follows, and o was regarded as pass and x was regarded as fail.
o: The viscosity recovery rate is 90% or more.
x: The viscosity recovery rate is less than 90%.

### (Flip-Flop Property (FF Property))

L values were measured at measurement angles of 25 degrees and 75 degrees using “CM-512m3” (multi-angle spectrophotometer manufactured by KONICA MINOLTA, INC.), and then an FF value (L value at 25 degrees/L value at 75 degrees) was calculated.

The evaluation criteria are as follows, and o was regarded as pass and x was regarded as fail.
o: The FF value is 2.2 or more.
x: The FF value is less than 2.2.

TABLE 3

| | | | Example 1 | Example 2 | Example 3 | Example 4 | Example 5 |
|---|---|---|---|---|---|---|---|
| Formulation | Hydroxy | B-1 | 55 parts | | | | |
| of coloring | group- | B-2 | | 55 parts | | | 55 parts |
| base coating | containing | B-3 | | | 55 parts | 45 parts | |
| material | acrylic resin | B-4 | | | | | |
| | (B) | B-5 | | | | | |
| | | B-6 | | | | | |
| | | B-7 | | | | | |
| | | B-8 | | | | | |
| | | B-9 | | | | | |
| | | B-10 | | | | | |
| | Blocked isocyanate compound (C) | | 15 parts | 15 parts | 15 parts | 20 parts | 15 parts |
| | Acrylic resin | E-1 | 30 parts | 30 parts | 30 parts | 35 parts | 30 parts |
| | (E) | E-2 | | | | | |
| | | E-3 | | | | | |
| | Crosslinked | D-1 | 20 parts | | | | |
| | polymer fine | D-2 | | 20 parts | 20 parts | 15 parts | 30 parts |
| | particles (D) | | | | | | |
| | Pigment (A) | Pigment concentration PWC (%) | 15% | 15% | 15% | 15% | 15% |

| | | | | | | |
|---|---|---|---|---|---|---|
| Evaluation | Solid content at the time of coating application: | ◯ | ◯ | ◯ | ◯ | ◯ |
| item | 35% or more = ◯ | | | | | |
| | Unevenness of coating film | ◯ | ◯ | ◯ | ◯ | ◯ |
| | Adhesion | ◯ | ◯ | ◯ | ◯ | ◯ |
| | Water resistance | ◯ | ◯ | ◯ | ◯ | ◯ |
| | Coating film hardness | ◯ | ◯ | ◯ | ◯ | ◯ |
| | Viscosity recovery rate [%] | ◯ | ◯ | ◯ | ◯ | ◯ |
| | FF property | ◯ | ◯ | ◯ | ◯ | ◯ |

TABLE 4

| | | | Comparative | Comparative | Comparative | Comparative | Comparative | Comparative |
|---|---|---|---|---|---|---|---|---|
| | | | Example 1 | Example 2 | Example 3 | Example 4 | Example 5 | Example 6 |
| Formulation | Hydroxy | B-1 | | | | | | |
| of coloring | group- | B-2 | | | | | | |
| base coating | containing | B-3 | | | | | | |
| material | acrylic resin | B-4 | 55 parts | | | | | |
| | (B) | B-5 | | 55 parts | | | | |
| | | B-6 | | | 55 parts | | | |
| | | B-7 | | | | 55 parts | | |
| | | B-8 | | | | | 55 parts | |
| | | B-9 | | | | | | 55 parts |
| | | B-10 | | | | | | |
| | Blocked isocyanate compound (C) | | 15 parts | 15 parts | 15 parts | 20 parts | 15 parts | 15 parts |
| | Acrylic resin | E-1 | 30 parts | 30 parts | 30 parts | 35 parts | 30 parts | 30 parts |
| | (E) | E-2 | | | | | | |
| | | E-3 | | | | | | |
| | Crosslinked | D-1 | 20 parts | | | | | |
| | polymer fine | D-2 | | 20 parts | 20 parts | 15 parts | 30 parts | 20 parts |
| | particles (D) | | | | | | | |
| | Pigment (A) | Pigment concentration PWC (%) | 15% | 15% | 15% | 15% | 15% | 15% |

| | | | | | | | |
|---|---|---|---|---|---|---|---|
| Evaluation | Solid content at the time of coating application: | X | ◯ | ◯ | ◯ | ◯ | ◯ |
| item | 35% or more = ◯ | | | | | | |
| | Unevenness of coating film | — | ◯ | ◯ | ◯ | ◯ | ◯ |
| | Adhesion | — | ◯ | ◯ | ◯ | X | ◯ |
| | Water resistance | — | X | ◯ | X | X | X |
| | Coating film hardness | — | X | X | ◯ | ◯ | ◯ |
| | Viscosity recovery rate [%] | — | ◯ | ◯ | ◯ | ◯ | ◯ |
| | FF property | — | ◯ | ◯ | ◯ | ◯ | ◯ |

| | | | Comparative | Comparative | Comparative | Comparative | Comparative | Comparative |
|---|---|---|---|---|---|---|---|---|
| | | | Example 7 | Example 8 | Example 9 | Example 10 | Example 11 | Example 12 |
| Formulation | Hydroxy | B-1 | | | | 60 parts | | 55 parts |
| of coloring | group- | B-2 | | | 55 parts | | 70 parts | |
| base coating | containing | B-3 | | 55 parts | | | | |
| material | acrylic resin | B-4 | | | | | | |
| | (B) | B-5 | | | | | | |
| | | B-6 | | | | | | |
| | | B-7 | | | | | | |
| | | B-8 | | | | | | |
| | | B-9 | | | | | | |
| | | B-10 | 55 parts | | | | | |
| | Blocked isocyanate compound (C) | | 15 parts | 15 parts | 15 parts | None | 30 parts | 15 parts |
| | Acrylic resin | E-1 | 30 parts | | | 40 parts | None | 30 parts |
| | (E) | E-2 | | 30 parts | | | | |
| | | E-3 | | | 30 parts | | | |
| | Crosslinked | D-1 | | 20 parts | 20 parts | | | None |
| | polymer fine | D-2 | 20 parts | | | 20 parts | | |
| | particles (D) | | | | | | | |
| | Pigment (A) | Pigment concentration PWC (%) | 15% | 15% | 15% | 15% | 15% | 15% |

| | | | | | | | |
|---|---|---|---|---|---|---|---|
| Evaluation | Solid content at the time of coating application: | ◯ | ◯ | X | ◯ | X | X |
| item | 35% or more = ◯ | | | | | | |
| | Unevenness of coating film | ◯ | X | — | ◯ | — | — |
| | Adhesion | ◯ | X | — | ◯ | — | — |
| | Water resistance | X | X | — | X | — | — |
| | Coating film hardness | ◯ | ◯ | — | X | — | — |
| | Viscosity recovery rate [%] | ◯ | X | — | ◯ | — | — |
| | FF property | ◯ | X | — | ◯ | — | — |

The starting materials shown in Tables 3 and 4 (excluding Production Examples 1 to 17) are described.
Blocked isocyanate compound (C): manufactured by Asahi Kasei Chemical Corporation, trade name: DURANATE MF-K60B
Pigment (A): aluminum (scaly pigment), manufactured by Toyo Aluminium K.K., trade name: ALPASTE 07-0674
Organic solvent: methyl amyl ketone, Solvesso 100 (manufactured by Exxon Mobil Corporation)

The coated articles of Examples 1 to 5 satisfying the requirements prescribed in the embodiment of the present invention each include a base coating film being superior in adhesion and water resistance and having less unevenness of the coating film. In addition, the flip-flop property (FF property) provided by the scaly pigment is also superior. In Comparative Example 1, since the weight average molecular weight of the hydroxy group-containing acrylic resin (B) was more than 20,000 and the nonvolatile content was less than 35% when the viscosity was adjusted to a prescribed value, the product was not a high solid content type coating material, and other evaluation tests were not carried out. In Comparative Example 2, contrary to Comparative Example 1, the weight average molecular weight of the hydroxy group-containing acrylic resin (B) is 10,000 or less, and there are defects in the water resistance of the coating film and the hardness of the coating film. In Comparative Example 3, the glass transition temperature Tg of the hydroxy group-containing acrylic resin (B) is as low as −10° C., and the hardness of the coating film is not sufficient. In Comparative Example 4 had a glass transition temperature Tg as high as 45° C. contrary to Comparative Example 3, and there was a problem in the water resistance of the coating film. In Comparative Examples 5 and 6, the hydroxyl value of the hydroxy group-containing acrylic resin (B) was less than 10 mg KOH/g (Comparative Example 5) or higher than 50 mg KOH/g (Comparative Example 6). There were problems in adhesion and water resistance in Comparative Example 5, and water resistance was insufficient in Comparative Example 6. In Comparative Example 7, since the hydroxy group-containing acrylic resin (B) does not include any lactone-modified methacrylate, water resistance is insufficient. In Comparative Examples 8 and 9, the weight average molecular weight of the second acrylic resin (E) was as low as 2000 in Comparative Example 8 and as high as 9500 in Comparative Example 9. The coating film performance was insufficient in many items in Comparative Example 8. In Comparative Example 9, since the nonvolatile content was less than 35% when the viscosity was adjusted to a prescribed value, the product was not a high solid content type coating material, and other evaluation tests were not carried out. In Comparative Example 10, the product does not contain a blocked isocyanate compound and is not crosslinked, so that the water resistance and the hardness of the coating film among the coating film performance are insufficient. In Comparative Example 11, since the second acrylic resin (E) was not added and the nonvolatile content was less than 35% when the viscosity was adjusted to a prescribed value, the product was not a high solid content type coating material, and other evaluation tests were not carried out. In Comparative Example 12, since the coating material did not contain the crosslinked polymer fine particles (D) and the nonvolatile content was similarly less than 35% when the viscosity was adjusted to a prescribed value, the product was not a high solid content type coating material, and other evaluation tests were not carried out.

1. A base coating composition comprising:
a pigment (A);
a hydroxy group-containing acrylic resin (B);
a blocked isocyanate compound (C);
crosslinked polymer fine particles (D) insoluble and stably dispersed in a solution of the hydroxy group-containing acrylic resin (B) and
an acrylic resin (E) having a weight average molecular weight different from that of the hydroxy group-containing acrylic resin (B),
wherein
the base coating composition has a solid content of 35% by mass or more,
when, using a cone-plate viscometer, a viscosity V1 is measured at a shear of 0.1/sec at 23° C., then the shear is changed from 0.1/sec to 25000/sec and applied for 30 seconds, and
subsequently a viscosity V2 is measured after the shear is returned to 0.1/sec and then applied for one second, a viscosity recovery rate V2/V1, which is a ratio of V2 to V1, is 90% or more,
the pigment (A) comprises one or more pigment selected from the group consisting of coloring pigments and scaly pigments.
the hydroxy group-containing acrylic resin (B)
is a polymer of one or more monomers including a hydroxy group-containing monomer (b), wherein the hydroxy group-containing monomer (b) is a lactone-modified product of a monoester compound of (meth)acrylic acid and a dihydric alcohol having 2 or more and 8 or less carbon atoms,
has a weight average molecular weight of 10,000 or more and 20,000 or less,
has a glass transition temperature of 10° C. or higher and 40° C. or lower, and
has a hydroxyl value of 10 mg KOH/g or more and 50 mg KOH/g or less, and
the acrylic resin (E) has a weight average molecular weight of 3000 or more and 7500 or less.

2. The base coating composition of claim 1, wherein
the hydroxy group-containing acrylic resin (B) is a polymer of the hydroxy group-containing monomer (b) and another monomer other than the hydroxy group-containing monomer (b), and
the hydroxy group-containing monomer (b) accounts for 5% by mass or more and 20% by mass or less in the total amount of the hydroxy group-containing monomer (b) and the other monomer.

3. A coated article comprising:
an article to be coated and;
a base coating film formed from the base coating composition of claim 1.

4. The coated article of claim 3, comprising a multilayer coating film including a base coating film provided on the article to be coated and a clear coating film provided on the base coating film.

5. The coated article of claim 3, comprising a multilayer coating film including a base coating film provided on the article to be coated provided in advance with an intermediate coating film or a primer coating film, and a clear coating film provided on the base coating film.
